(19) United States
(12) Patent Application Publication
(10) Pub. No.: US 2015/0151354 A1
(43) Pub. Date: Jun. 4, 2015

(54) Fitting Tool

(71) Applicant: TKR SPEZIALWERKZEUGE GMBH, Gevelsberg (DE)

(72) Inventor: Thorsten Weyland, Schwerte (DE)

(21) Appl. No.: 14/412,438

(22) PCT Filed: Jul. 10, 2013
(86) PCT No.: PCT/EP2013/064606

§ 371 Date: Dec. 31, 2014

(30) Foreign Application Priority Data
Jul. 10, 2012 (DE) 10 2012 106 194.7

(51) Int. Cl. B21J 15/38; B25B 11/00

(52) U.S. Cl. CPC B21J 15/38; B25B 11/002

(57) ABSTRACT

The invention relates to a fitting tool for installing a multipart clamping insert in a blind rivet tool. In order to provide a fitting tool for particularly easy and quick fitting of clamping jaws of a clamping insert in a blind rivet tool, provision is made for the fitting tool to have a main body having a mounting section for magnetically fixing the clamping jaws forming the clamping insert.

### BACKGROUND OF THE INVENTION

1. Field of the Invention

The invention relates to a fitting tool for installing a multipart clamping insert in a blind rivet tool, and a method for fitting a multipart clamping insert in a blind rivet tool.

2. Description of Related Art

Blind rivet tools for setting blind rivets that, for example are driven pneumatically, hydraulically and/or electrically, are used inter alia in automotive repair shops. The clamping inserts used in the blind rivet tool have a plurality of clamping jaws that clamp and tear off a pin of the blind rivet while the blind rivet is being set. Each clamping insert can be used for a specific range of diameters of blind rivet pins. If the diameter of a blind rivet pin is larger or smaller than the gripping area of the inserted clamping insert, the clamping insert must be changed so that the blind rivet tool can still be used.

Normally, the clamping insert is exchanged by unscrewing a tool cover with a blind rivet port arranged above the clamping insert so that the person operating the blind rivet tool can remove the clamping insert from the blind rivet tool and insert another clamping insert.

With blind rivet tools without an unscrewable blind rivet port, assuming that the clamping jaws are exchangeable, the blind rivet pin discharge arranged in a tool base is designed to be releasable from the blind rivet tool. It is, however, significantly more difficult to change the clamping insert from the side of the tool base since the distance between the tool base and the position of the clamping insert is significantly larger than the distance between the tool cover and clamping insert position.

### BRIEF SUMMARY OF THE INVENTION

The object of the invention is therefore to provide a fitting tool for fitting clamping jaws of a clamping insert in a blind rivet tool in a particularly easy and quick manner, and to propose a corresponding method for fitting the clamping jaws.

The invention achieves the object with a fitting tool having the features of claim 1. Advantageous further developments of the inventions are specified in the dependent claims.

The fitting tool according to the invention for installing a multi-part clamping insert in a blind rivet tool comprises a main body that has a mounting section for magnetically fixing the clamping jaws forming the clamping insert.

Within the context of the present application, a fitting tool is to be understood as an auxiliary device for inserting the clamping jaws into the blind rivet tool. In a particularly easy manner, the fitting tool makes it possible to bridge the distance between the tool base when installing the clamping insert, i.e., the area of the blind rivet tool from which the blind rivet pin torn off when riveting blind rivets is ejected, and the tool cover below which the clamping insert is arranged during operation. This allows the installation (exchange), and possibly also the removal, of the clamping insert to be performed quite rapidly and precisely.

Because of its particularly simple design consisting of the main body and the mounting section, the fitting tool is very economical and easy to manufacture or quickly replaceable when lost while the repair shop is operating. Furthermore, the fitting tool is insensitive to damage which can easily occur while the repair shop is operating.

Magnetic fixation furthermore allows all of the different sizes of clamping inserts to be installed, i.e., clamping inserts for different ranges of diameters of blind rivets pins, providing that they have a ferromagnetic design.

The multi-part clamping insert consists of at least two, and preferably three or four individual clamping jaws. Clamping inserts for particularly large rivet pin diameters can also have more than four clamping jaws.

The clamping jaws have a contact surface that is designed to grip the blind rivet pin. When fixing and aligning the clamping jaws on the fitting tool, they are arranged with the contact surface on the mounting section.

The main body and the mounting section can be designed in two or more parts. It is therefore possible, for example, to connect a first main body to an adjacent mounting section body, and/or to arrange other main bodies on the mounting section/first main body. The connection can be designed, for example, releasable, in particular screwable. Advantageously, the mounting section is, however, a component of the main body and is hence designed integrally with and unreleasable from the main body.

The mounting section on the main body can be arranged on one end of the main body, i.e., form one end of the main body. The mounting section can also be arranged between a first and a second end of the main body. In this case, the main body has two main body areas that each border the mounting section.

The main body can consist of any material such as a plastic, ceramic and/or ferromagnetic material such as a high-grade steel.

The magnetic design of the mounting section causing it to exert magnetic attraction on ferromagnetic materials is freely selectable in principle. For example, the entire mounting section can be formed from a magnetic material.

According to a further embodiment of the invention, the mounting section has a magnetic body, however. The surface of the mounting section can, for example, be formed completely from a magnetic body.

The mounting section can, however, comprise the entire main body. That is, the entire main body is formed as a magnetic body. However, a single, separately-formed magnetic body is advantageously arranged in the area of the mounting section.

The magnetic body is for example adhered to the mounting section or main body, and/or clamped thereto. It is hence advantageously unreleasably connected to the main body or the mounting section.

The shape of the magnetic body can for example be designed elongated and/or extend along an axial longitudinal axis of the main body. The magnetic body can also have an annular shape.

It is particularly preferable for the mounting section to have at least two magnetic bodies that are arranged to run in the direction of the longitudinal axis, and/or around the longitudinal axis of the main body, and are arranged offset from each other. It is therefore possible, for example, in the arrangement of more than two magnetic bodies, to arrange the magnetic bodies both in the direction of the longitudinal axis as well as around the longitudinal axis and always offset from each other in order to produce, for example, a spiral arrangement around to the longitudinal axis. The magnetic body is preferably designed round, in particular disc shaped or pin shaped.

A surface of the magnetic bodies can for example be arranged flush with the surface of the mounting section. According to one particularly preferred development of the invention, the magnetic body is, however, arranged in a cutout in the mounting section, preferably recoiling from the surface of the mounting section. A magnetic body arranged in this manner makes it particularly simple and easy to position (affix and align) the clamping jaws in the area of the mounting section.

In their installed position within the blind rivet tool, the clamping jaws are arranged coaxial to an insertion area in the blind rivet tool in which the blind rivet pin can be inserted through the blind rivet port into the blind rivet tool. It is particularly preferable for the main body to be designed rod-shaped to allow the main body to be introduced with particular facility into the blind rivet tool, and to allow the clamping jaws to be positioned particularly easily in the operating position within the blind rivet tool. In this regard, the main body can, for example, have an angular or polygonal cross-section. It is advantageously designed round, however, and the diameter is adapted to the diameter of the blind rivet pin port and/or the blind rivet pin discharge.

To make it easier to position the clamping jaws in the blind rivet tool and in particular to securely fix the clamping jaws on the mounting section, the diameter of the main body in the area of the mounting section has a reduced diameter relative to a main body area bordering the area of the mounting section. Both in the case of a single part and multipart design of the main body with the mounting section, the transition from the diameter of the mounting section to the adjacent main body can for example be stepless, i.e., without forming an edge.

Advantageously, a step is formed in the area of the transition, however, which is designed in particular as a stop for the clamping jaws. The mounting section can therefore be designed as a recess in the main body, for example. Preferably, the recess encircles the main body, i.e., it is formed to run around the longitudinal axis of the main body/mounting section and extends over the entire perimeter of the main body and has a consistently unchanging depth. The clamping jaws can thereby be fixed particularly easily on the mounting section and on a circular path around the longitudinal axis.

The fitting tool can be inserted into the blind rivet tool from the rivet pin port side of the blind rivet tool, or from the rivet pin ejection side of the blind rivet tool, providing that a blind rivet pin receptacle is not attached to the blind rivet tool. To make insertion particularly easy, according to a further embodiment of the invention, the main body has at least one end with a tapering shape.

The one end of the main body can hence be designed e.g. rounded, arced and/or tapering. The tapering shape, i.e., the end of the main body, can however also have the shape of a cone (conical section)/pyramid (pyramidal section).

To be able to use the fitting tool in a particularly varied manner, the main body of the fitting tool is adapted to the blind rivet tool, i.e., its size (shape, length and diameter) is adapted to a blind rivet tool such that it is particularly preferably designed to be insertable into a blind rivet port and/or into a blind rivet pin discharge of the blind rivet tool.

To render the fitting tool easy to handle, the fitting tool is designed such that at least one end extends out of the blind rivet tool in the inserted position. The main body can also be designed such that a first end of the inserted main body extends out of the blind rivet port, and a second end extends out of the blind rivet pin discharge.

The object of the invention is furthermore achieved with a method for fitting a multipart clamping insert into a blind rivet tool having the features of claim 9.

The method according to the invention for fitting a multipart clamping insert into a blind rivet tool comprises the steps:
aligning and magnetically fixing the clamping jaws of a clamping insert in a fitting tool,
inserting a section of the fitting tool, with the clamping insert arranged therein, into the open blind rivet tool, and positioning the clamping insert in the blind rivet tool,
closing the blind rivet tool by connecting a blind rivet tool insert to the blind rivet tool,
removing the fitting tool from the blind rivet tool.

The method according to the invention makes it possible to precisely and very quickly install the clamping insert in the blind rivet tool, and additionally prevents an operator from using unsuitable tools that, however, are normal in a repair shop, such as a screwdriver, to install a clamping insert in a blind rivet tool which in many cases causes damage to the blind rivet tool, the blind rivet insert or the clamping insert.

For their alignment, the clamping jaws are (manually) placed by the operator on the fitting tool, in particular in the area of the mounting section arranged on a main body. The magnetically designed mounting section acts on the clamping jaws and draws them toward it, and releasably fixes the clamping jaws via a contact surface on the surface of the mounting section.

The clamping jaws are aligned depending on the required position of the clamping jaws within the blind rivet tool; however, they are advantageously aligned with the most uniform spacing possible from each other around a longitudinal axis of the fitting tool. To this end, marks, for example, can be arranged on the fitting tool which identify the correct position of the clamping jaws. For example, recesses, notches or purely visual marks can be arranged such as, e.g., colored marks.

The length of the fitting tool is adapted to the blind rivet tool such that the fitting tool can be introduced into the blind rivet tool, and possibly shoved through the blind rivet tool. For improved handling in the inserted position, a section of the fitting tool, possibly an additional handle area or, for example, even the main body, advantageously extends out of the blind rivet tool. Hence only a section of the fitting tool is introduced into the blind rivet tool.

When inserting the fitting tool, the blind rivet tool is opened, i.e., a tool base comprising the blind rivet discharge was removed from the blind rivet tool before introducing, and a blind rivet tool insert that is arranged in the blind rivet tool and which may block access to the clamping jaws was removed from the blind rivet tool.

Upon being inserted, the fitting tool was positioned with the clamping insert fixed on the mounting area such that the clamping insert assumes the predetermined position during operation for gripping a blind rivet pin.

After the clamping insert is positioned, the blind rivet tool is closed by introducing the blind rivet insert, which may have been removed, by means of the fitting tool into the blind rivet tool, and the tool base is connected, e.g. screwed, to the blind rivet tool.

Alternately, the removed blind rivet insert and possibly the tool cover can also be arranged on the mounting section and/or on the main body of the fitting tool before magnetically fixing and aligning the clamping jaws such that the fitting tool is introduced with the clamping jaws, and possibly together with the blind rivet insert, and/or the tool cover into the blind rivet tool.

The fitting tool is subsequently removed from the blind rivet tool by the operator by pulling the fitting tool out of the blind rivet pin discharge or the blind rivet port.

According to a further embodiment of the invention, an additional clamping insert to be exchanged that is already arranged in the blind rivet tool is removed before fitting the clamping insert. This occurs with the steps:
introduction of a section of the fitting tool into the blind rivet tool,
disconnection of the blind rivet insert connected to the blind rivet tool,
removal of the blind rivet insert, the fitting tool and another clamping insert magnetically affixed to the fitting tool from the blind rivet tool,
removal of the existing additional clamping insert from the fitting tool.

Disassembling the blind rivet tool with the fitting tool makes it possible to controllably, and in particular quickly, disassemble the blind rivet tool in order to replace the installed clamping insert with another clamping insert. Removal with the fitting tool ensures that all of the components removed from the blind rivet tool remain on the fitting tool, which makes it possible to quickly change the clamping jaws and subsequently completely install all of the components, and time-consuming assembly and introduction of the individually removed components can be avoided.

The fitting tool is introduced into the blind rivet tool corresponding to the introduction when installing the clamping jaws. That is, the fitting tool with the main body and mounting section is inserted into the tool through the blind rivet pin discharge or the blind rivet holder of the blind rivet tool. The fitting tool may also be pushed through the blind rivet tool such that its first section extends out of the blind rivet holder, and/or its second section extends out of the blind rivet discharge.

The blind rivet insert was disconnected by unscrewing a blind rivet tool cap comprising the blind rivet pin discharge. A blind rivet insert such as various springs which may be positioned below the tool cap is also disconnected and removed from the blind rivet tool.

From the previous insertion of the fitting tool, the blind rivet insert and possibly the tool cap are threaded onto the fitting tool such that the clamping insert magnetically affixed to the fitting tool can be removed, together with the blind rivet insert and/or the tool cap, from the blind rivet tool. Subsequently, the additional clamping insert can be removed from the mounting section without disconnecting the blind rivet insert and/or the tool cap from the fitting tool.

Then the (new) clamping insert is magnetically affixed to the fitting tool, aligned, and fitting can commence again.

According to a further embodiment of the invention, the fitting tool is positioned while being inserted into the blind rivet tool such that a mounting section that is arranged on the fitting tool and designed to magnetically affix the clamping jaws of the additional clamping insert is in magnetic contact with the clamping jaws of the additional clamping insert.

Depending on whether the mounting section is arranged at one end of the main body of the fitting tool or between the two ends of a main body, the mounting section must be correspondingly positioned in the area of the blind rivet tool, in which the additional clamping jaw insert is to be inserted. To the extent that the main body of the fitting tool is designed entirely as a mounting section, the fitting tool can be inserted into the blind rivet tool quite easily without having to be positioned. However, to the extent that the mounting section only comprises a portion of the fitting tool (main body designed as a single part or multiple parts) and mounting section, positioning occurs. To this end, a mark can be provided on the main body of the fitting tool which is visible for the operator. The mark can for example identify the necessary insertion depth of the fitting tool into the blind rivet tool such that the operator can identify when the mounting section arranged on the main body is in magnetic contact with the additional clamping insert.

### BRIEF DESCRIPTION OF THE SEVERAL VIEWS OF THE DRAWINGS

The invention will be further explained below with reference to an exemplary embodiment. In the figures:

FIG. 1 schematically portrays an exploded view of an opened blind rivet tool with a fitting tool; and

FIG. 2 schematically portrays an opened blind rivet tool with a hydraulic connection, and a fitting tool prepared to be inserted into the blind rivet tool.

### DETAILED DESCRIPTION OF THE INVENTION

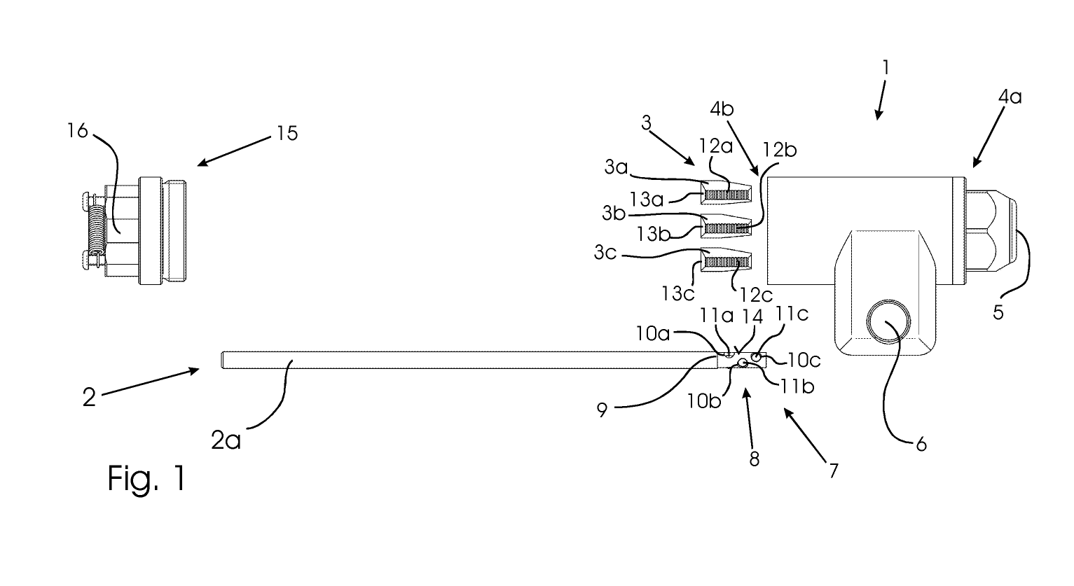

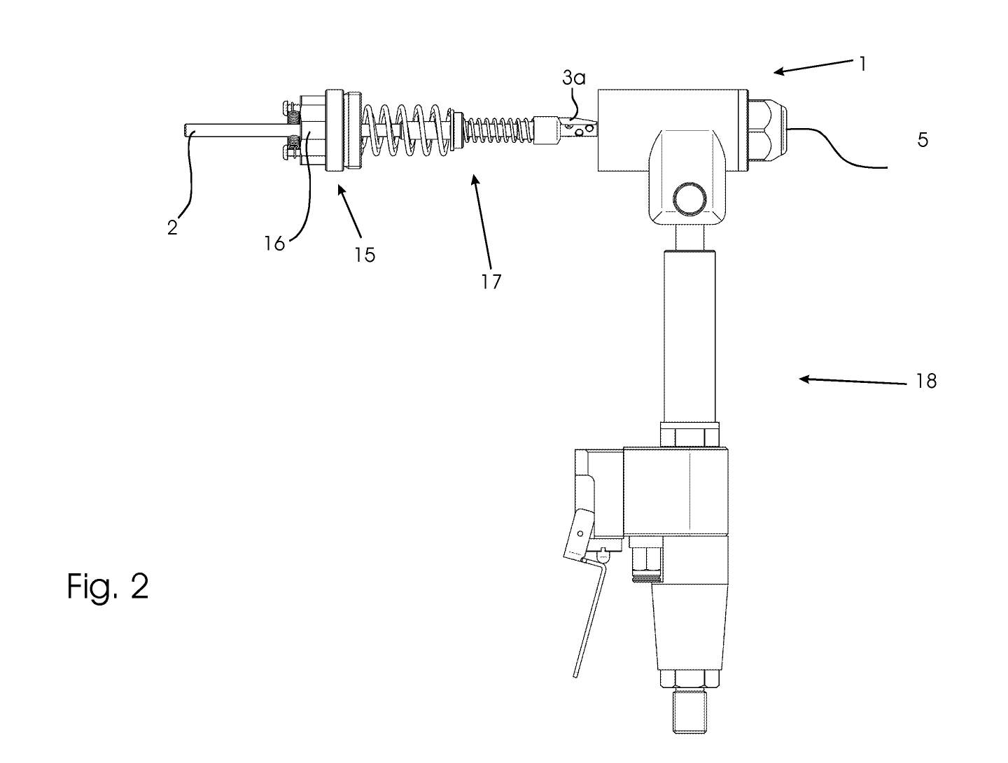

FIG. 1 shows an opened blind rivet tool 1 with a separate tool base 15, a fitting tool 2 and a clamping insert 3 which consists of three clamping jaws 3a, 3b, 3c. At a front side 4a, the blind rivet tool 1 has a blind rivet holder 5 for introducing a blind rivet pin (not shown). The blind rivet tool 1 is designed to be toggle connected to a hydraulic control unit 18 via a toggle connection 6 (see FIG. 2).

The fitting tool 2 has a rod-shaped main body 2a consisting of a ferromagnetic material, in this case high-grade steel. The diameter of the main body 2a is adapted to the diameter of the blind rivet holder 5, i.e., the outer diameter of the main body 2a is preferably slightly less than the inner diameter of the blind rivet holder 5 such that the fitting tool 2 can be inserted through the blind rivet holder 5 into the blind rivet tool 1, or pulled out of the blind rivet tool 1 and through the blind rivet holder 5. A mounting section 8 integrally formed with the main body 2a is arranged on a front end 7 of the fitting tool 2. The mounting section 8 is set back at a consistent distance with respect to the main body 2a, i.e., the diameter of the mounting section 8 is uniformly less than the diameter of the main body 2a.

A stop edge 9 in the form of a shoulder is formed at the transition between the diameter of the mounting section 8 and the diameter of the main body 2a. The stop edge 9 is designed as a contact edge for the clamping jaws 3a, 3b, 3c in the axial direction of the main body 2a.

Furthermore, FIG. 1 has three cutouts 10a, 10b, 10c in the area of the mounting section 8. The cutouts 10a, 10b, 10c are arranged offset from each other both in the direction of the longitudinal axis as well as around the longitudinal axis of the main body 2a such that the cutouts 10a, 10b, 10c are arranged helically around the longitudinal axis of the fitting tool 2. The cutouts 10a, 10b, 10c are designed as holes which penetrate the mounting section 8. Rod shaped magnetic bodies 11a, 11b, 11c are arranged in the cutouts 10a, 10b, 10c and are securely adhered to the mounting section 8. Alternately, the magnetic bodies 11a, 11b, 11c can also be, for example, clamped into the cutouts 10a, 10b, 10c. The magnetic bodies 10a, 10b, 10c are set back with respect to a surface 14 of the mounting section 8.

The clamping jaws 3a, 3b, 3c portrayed in FIG. 1 each have a wavy contact surface 12a, 12b, 12c and a positioning edge 13a, 13b, 13c. The positioning edges 13a, 13b, 13c are designed for the clamping jaws 3a, 3b, 3c to contact the contact edge 9 between the main body 2a and the mounting section 8.

To install the clamping jaws 3a, 3b, 3c in the blind rivet tool 1, the clamping jaws 3a, 3b, 3c are placed next to each other on the fitting tool 2 in the area of the mounting section 8. The clamping jaws 3a, 3b, 3c are designed ferromagnetic. The clamping jaws 3a, 3b, 3c are fixed by the magnetic bodies 11a, 11b, 11c on the mounting section 8 such that the contact surfaces 12a, 12b, 12c of the clamping jaws 3a, 3b, 3c rest on the surface 14 of the mounting section 8, and the respective leading edge 13a, 13b, 13c touches the stop edge 9.

The clamping insert 3 fixed in this manner to the mounting section 8 can be inserted into the rear side 4b of the blind rivet tool 1 opposite the blind rivet holder 5 and correspondingly positioned in the blind rivet tool 1 adjacent to the blind rivet holder 5 in its operating position.

After the clamping insert 3 is positioned, the blind rivet tool insert 17 (see FIG. 2) is guided by means of the fitting tool 2 and inserted into the blind rivet tool 1. Then the tool base 15 with rivet pin discharge 16 that belongs to the blind rivet tool insert 17 is guided also by means of the fitting tool 2 and is securely connected to the rear side 4b of the blind rivet tool 1. The fitting tool 2 extends out of the rivet pin discharge 16 of the tool base 15 and can be removed by an operator (not shown) of the blind rivet tool 1 out of the closed blind rivet tool 1. Since it is exclusively fixed magnetically, the clamping insert 3 slips off from the fitting tool when the fitting tool 2 is removed, and it remains in its operating position in the blind rivet tool 1.

FIG. 2 shows the blind rivet tool 1 from FIG. 1 with a connected hydraulic control unit 18. FIG. 2 shows an alternative installation option for the clamping insert 3. As described above, the clamping insert 3 is fixed to the mounting section 8. For the sake of clarity, only one clamping jaw 3a of the clamping insert 3 is depicted in FIG. 2. Subsequently and before being introduced into the blind rivet tool 1, additional components of a blind rivet tool insert 17 and the tool base 15 are threaded on the fitting tool 2 such that the fitting tool 2 extends out of the blind rivet pin discharge 16 of the tool base 15.

The blind rivet tool insert 17 and the clamping insert 3 threaded in this manner onto the fitting tool 2 are introduced into the blind rivet tool 1, and the tool base 15 is connected to the blind rivet tool 1, screwed in this case. Then the fitting tool 2 is again also removed in a particularly easy manner from the rivet pin discharge 16.

Alternatively, it is for example also possible to design the fitting tool 2 without a contact edge 9 such that the fitting tool 2 can be pulled out of the blind rivet holder 5 of the blind rivet tool 1. This makes it possible to also use the fitting tool 2 when the blind rivet tool 1 is designed with for example a receptacle (not shown) arranged on the tool base 15 for the blind rivet pins (not shown) torn off of the blind rivets.

Corresponding to the depiction in FIG. 2, the clamping insert 3 can also be removed by: Inserting the fitting tool 2 into the blind rivet tool 1 closed with the tool base 15, disconnecting the tool base 16 from the blind rivet tool 1, and then removing the clamping insert 3 fixed by the magnetic bodies 11a, 11b, 11c to the mounting section 8 of the fitting tool 2, the blind rivet tool insert 17, and the tool base 15, from the blind rivet tool 1. The fitting tool 2 can either be inserted through the tool base 15 or through the blind rivet holder 5 given a corresponding design of the fitting tool 2 (see above).

It is subsequently possible in a particularly easy manner to exchange exclusively the clamping insert 3 with e.g. another clamping insert (not shown) having e.g. another rivet pin diameter, and to introduce again the fitting tool 2 with the already threaded blind rivet tool insert 17, the tool base 15 and the additional (new) clamping insert, into the blind rivet tool 1.

1. A fitting tool for installing a multipart clamping insert in a blind rivet tool with a main body which has a mounting section for magnetically
fixing the clamping jaws forming the clamping insert.

2. The fitting tool according to claim 1, wherein the mounting section has a magnetic body.

3. The fitting tool according to claim 2, wherein the magnetic body is arranged in a cutout in the mounting section, preferably set back with respect to the surface of the mounting section.

4. The fitting tool according to claim 1, wherein the mounting section has at least two magnetic bodies that are arranged offset from each other in a direction of a longitudinal axis and/or running around the longitudinal axis.

5. The fitting tool according to claim 1, wherein the main body is designed rod-shaped.

6. The fitting tool according to claim 1, wherein a diameter of the main body has a smaller diameter in an area of the mounting section which is less than a main body area adjacent to the area of the mounting section.

7. The fitting tool according to claim 1, wherein at least one end of the main body has a tapering shape.

8. The fitting tool according to claim 1, wherein the main body is designed to be insertable into a blind rivet holder and/or into a rivet pin discharge of the blind rivet tool.

9. A method for fitting a multipart clamping insert in a blind rivet tool, comprising the steps:
aligning and magnetically fixing clamping jaws of a clamping insert in a fitting tool.
inserting a section of the fitting tool, with the clamping insert arranged therein, into the open blind rivet tool, and positioning the clamping insert in the blind rivet tool,
closing the blind rivet tool by connecting a blind rivet tool insert to the blind rivet tool,
removing the fitting tool from the blind rivet tool.

10. The method according to claim 9, wherein an additional clamping insert arranged in the blind rivet tool is removed before fitting the clamping insert, comprising the steps:
introducing a section of the fitting tool in the blind rivet tool,
disconnecting the blind rivet insert connected to the blind rivet tool,
removal of the blind rivet insert, fitting tool and another clamping insert magnetically affixed to fitting tool from the blind rivet tool,
removing the additional clamping insert from the fitting tool.

11. The method according to claim 10, wherein the fitting tool is positioned while being inserted into the blind rivet tool such that a mounting section that is arranged on the fitting tool and designed to magnetically affix the clamping jaws of the additional clamping insert is in magnetic contact with the clamping jaws of the additional clamping insert.

12. A use of a fitting tool for installing a multipart damping insert in a blind rivet tool, wherein the fitting tool has a main body which has a mounting section for magnetically fixing the clamping jaws forming the clamping insert.
